(19) United States
(12) Patent Application Publication
(10) Pub. No.: US 2022/0414458 A1
(43) Pub. Date: Dec. 29, 2022

(54) DEEP LEARNING NETWORK DEVICE, MEMORY ACCESS METHOD AND NON-VOLATILE STORAGE MEDIUM

(71) Applicant: NATIONAL CENTRAL UNIVERSITY, Taoyuan City (TW)

(72) Inventors: TSUNG-HAN TSAI, TAOYUAN CITY (TW); MUHAMMAD AWAIS HUSSAIN, TAOYUAN CITY (TW)

(21) Appl. No.: 17/406,458

(22) Filed: Aug. 19, 2021

(30) Foreign Application Priority Data
Jun. 24, 2021 (TW) 110123222

(51) Int. Cl. G06N 3/08

(52) U.S. Cl. CPC G06N 3/08

(57) ABSTRACT

A memory access method used when training a deep learning network is illustrated in the present disclosure. When calculating the weightings of the current layer to the previous layer, the differential terms generated by the weighting updating calculation from the next layer to the current layer are used for reducing the access number of accessing the memory. Since the memory access method greatly reduces the access number of accessing the memory, the training time and power consumption can be reduced, and the lifetime of the battery and memory of the deep learning network device can be prolonged. Especially in the case of limited battery power, the deep learning network device can run longer.

### TECHNICAL FIELD

The present disclosure relates to a deep learning network, in particularly to, a deep learning network that can reduce an access number of accessing the memory and power consumption in the training mode, and the memory access method used by the deep learning network.

### RELATED ART

The deep learning network technology is an important technology often used to realize artificial intelligence in the near future. The convolution neural network in the deep learning network includes a neural network composed of an input layer, at least one hidden layer and an output layer, wherein the neural network of the convolution neural network is even named by the full connection layer. Taking the neural network or full connection layer in FIG. 1 as example, the neural network or full connection layer has an input layer IL, two hidden layers L1, L2 and an output layer OL. Each of the input layer IL, the two hidden layers L1, L2 and the output layer OL will have more than one node, and the received value of a certain node of a certain layer is the weighting sum of the output values of nodes of the previous layer which are connected to it, and this node will input its received value into its activation function to produce the output value of this node.

For example, for the node H₃₁ of the hidden layer L2 in FIG. 1, the received value of the node H₃₁ is net_{H}_{₃₁}=w₉out_{H}_{₂₁}+w₁₁out_{H}_{₂₂}, and its output value is Act_fn(net_{H}_{₃₁}), wherein out_{H}_{₂₁} and out_{H}_{₂₂} are respectively the output values of the nodes H₂₁ and H₂₂ of the previous layer (hidden layer L1) which are connected to the node H₃₁, w₉ and w₁₁ are respectively the weightings of paths from the nodes H₂₁ and H₂₂ to the node H₃₁, and Act_fn is the activation function of the node H₃₁.

The weighting wₓ must be continuously updated to obtain the correct training results, so that the deep learning network can produce the precise determination result based on the input data in the determination mode. The most popular manner for updating the weighting wₓ is the back propagation manner, and its calculation equation is:

$${W}_{n e w} = {W}_{old} - η \frac{\partial L}{\partial {W}_{old}} , \qquad EQUATION ( 1 )$$

wherein W_{new} is the updated weighting vector, W_{Old} is the current weighting vector to be updated, η is the learning rate, and L is the loss function.

From the output layer to the previous layer (the last hidden layer), when updating the weighting wₓ of one path, in EQUATION (1), the derivative function of the loss function L over the weighting wₓ is

$$( \frac{\partial L}{\partial {w}_{x}} ) ,$$

and by using me chain rule, it can be rewritten as follows:

$$\frac{\partial L}{\partial {w}_{x}} = \frac{\partial L}{\partial {out}_{{O}_{x}}} \frac{\partial {out}_{{O}_{x}}}{\partial {net}_{{O}_{x}}} \frac{\partial {net}_{{O}_{x}}}{\partial {w}_{x}} , \qquad EQUATION ( 2 )$$

wherein out_{O}_{ₓ} is the output value of the node Oₓ of the output layer generated by inputting the received value of the output value of the node Oₓ into the activation function of the node Oₓ.

Take the relation of the nodes of the different layers shown in FIG. 2 as example, EQUATION (2) can be expressed as follows:

$$\frac{\partial L}{\partial {w}_{x}} = ( {out}_{{O}_{x}} - {Y}_{{O}_{x}} ) D ( Act\_fn ) {O}_{{H}_{i}} , \qquad EQUATION ( 3 )$$

wherein Y_{O}_{ₓ} is the target value of the output value of the node Oₓ of the output layer, D(Act_fn) is the derivative function of the activation function of the node Oₓ of the output layer, and O_{H}_{ᵢ} is the output value of the node Hᵢ corresponding to the weighting wₓ (i.e. the node Hᵢ of the last hidden layer connected to the node Oₓ of the output layer). When updating the weighting wₓ of the path from the output layer to the previous layer (i.e. the last hidden layer) and calculating the derivative function

$$( \frac{\partial L}{\partial {w}_{x}} )$$

of the loss function L over the weighting wₓ, to obtain the values of out_{O}_{ₓ}, O_{H}_{ᵢ} and Y_{O}_{ₓ}, the memory needs to be accessed three times (i.e. the access number is 3). Thus, when updating all weightings of all paths between the output layer and the last hidden layer, the memory needs to be accessed totally M_{OL}=3N_{Lk}N_{OL} times (i.e. the access number is M_{OL}=3N_{Lk}N_{OL}), wherein N_{Lk} and N_{OL} are respectively numbers of the nodes of the last hidden layer and the output layer. Take the neural network or the full connection layer of FIG. 1 as example, k=2.

When updating the weighting wₓ of the path from the last hidden layer to the previous hidden layer (or the input layer, if there is only one hidden layer in the neural network or the full connection layer), in EQUATION (1), by using the chain rule, the derivative function

$$( \frac{\partial L}{\partial {w}_{x}} )$$

of the loss function L over the weighting wₓ can be written as:

$$\frac{\partial L}{\partial {w}_{x}} = \frac{\partial L}{\partial {out}_{{H}_{x}}} \frac{\partial {out}_{{H}_{x}} \partial {net}_{{H}_{x}}}{\partial {net}_{{H}_{x}} \partial {w}_{x}} , \qquad EQUATION ( 5 )$$

wherein out_{H}_{ₓ} is the output value of the node Hₓ of the last hidden layer node Hₓ which is generated by inputting the received value of the node Hₓ into the activation function of the node Hₓ, and net_{H}_{ₓ} is the received value of the node Hₓ of the last hidden layer node Hₓ.

EQUATION (5) can be further expressed as:

$$\frac{\partial L}{\partial {w}_{x}} = {\sum }_{i = 1}^{n} [ ( {out}_{{O}_{i}} - {Y}_{{O}_{i}} ) {D ( Act\_fn )}_{{O}_{i}} {w}_{i} ] {D ( Act\_fn )}_{{H}_{p}} {O}_{{H}_{q}} , \qquad EQUATION ( 6 )$$

wherein Y_{O}_{ᵢ} is the target value of the output value of the node Oᵢ of output layer, D(Act_fn)_{O}_{ᵢ} is the derivative function of the activation function of the node Oᵢ of output layer, n is the number of the nodes of the output layer (n=N_{OL}), D(Act_fn)_{H}_{ₚ} is the derivative function of the activation function of the node Hₚ of the last hidden layer, wᵢ is the weighting of the path between the node Hₚ of the last hidden layer corresponding to wₓ and the node Oᵢ of the output layer, and O_{H}_{_{q}} is the output value of the node H_{q} corresponding to the weighting wₓ (i.e. the node H_{q} of the previous layer which is connected to the node Hₚ of the last hidden layer. When updating the weighting wₓ of the path from the last hidden layer to the previous layer (i.e. the second last hidden layer) and calculating the derivative function

$$( \frac{\partial L}{\partial {w}_{x}} )$$

of the loss function L over the weighting wₓ, to obtain the required values during calculating, the memory should be accessed (3N_{OL}+2) times, i.e. the access number of accessing the memory is (3N_{OL}+2).

Take the neural network or the full connection layer of FIG. 1 as example, when updating all the weightings of the paths from the second hidden layer to the first hidden layer, the memory is accessed totally M_{OL}=(3N_{OL}+2)N_{L1}N_{L2} times, wherein N_{L1} and N_{L2} are the numbers of the nodes of the first hidden layer and the second hidden layer (i.e. N_{L1}=s and N_{L2}=y). Still stake FIG. 1 as example, by using the above similar calculation, when updating all the weightings of the paths from the first hidden layer to the input layer, the memory is accessed totally M_{OL}=(3N_{OL}N_{L2}+N_{L2}+2)N_{IL}N_{L1} times, wherein N_{IL} the number of the nodes of the input layer (i.e. N_{IL}=m).

Regardless of whether transfer learning is used, the full connection layer of the convolution neural network or the neural network needs to be trained, and during training, the updating of the weighting closer to the input layer needs more access number of accessing the memory. Once the access number of accessing the memory is too large, the training time will be very time-consuming, and correspondingly, the power consumed by the memory will also increase. In some cases where an edge computing device needs to be used to train the full connection layer of the convolution neural network or the neural network, the method of above said related art cannot meet the requirements of the training time and the power consumption.

### SUMMARY

According to one objective of the present disclosure, a memory access method which is used when training a deep learning network is provided, wherein the deep learning network is a neural network or a convolution neural network, the neural network or a full connection layer of the convolution neural network comprises an input layer, L hidden layers and an output layer, and the memory access method comprises: updating weightings of paths between the output layer and a L^{th} hidden layer of the L hidden layers, and storing differential terms of all nodes of the output layer in a memory; updating weightings of paths between the L^{th} hidden layer and a (L−1)^{th} hidden layer of the L hidden layers based on the differential terms of the all nodes of the output layer stored in the memory, and storing differential terms of all nodes of the L^{th} hidden layer in the memory; updating weightings of paths between a j^{th} hidden layer of the L hidden layers and a (j−1)^{th} hidden layer of the L hidden layers based on differential terms of all nodes of a (j+1)^{th} hidden layer of the L hidden layers stored in the memory, and storing differential terms of all nodes of the j^{th} hidden layer in the memory, wherein j is an integer from 2 to (L−1); and updating weightings of paths between the input layer and a 1^{st} hidden layer of the L hidden layers based on differential terms of all nodes of a 2^{nd} hidden layer of the L hidden layers stored in the memory.

According to the above features, the deep learning network is a convolution neural network, and a transfer learning is used to only train the full connection layer of the convolution neural network.

According to the above features, the differential term of the node Oₓ of the output layer is expressed as:

Δ_{O}_{ₓ}=(out_{O}_{ₓ}−Y_{O}_{ₓ})D(Act_fn)_{O}_{ₓ};

wherein Y_{O}_{ₓ} is a target value of the node Oₓ of the output layer, D(Act_fn)_{O}_{ₓ} is a derivative function of an activation function of the node Oₓ of the output layer.

According to the above features, wherein the differential term of the node H_{Li} of the L^{th} hidden layer is expressed as:

Δ_{H}_{_{Li}}=(Σᵢ₌₁ⁿ[Δ_{O}_{ᵢ}wₓᵢ]);

wherein n is a number of the all nodes of the output layer, wₓᵢ is a weighting of a path between the node H_{Li} of the L^{th} hidden layer corresponding to a weighting wₓ and the node Oᵢ of the output layer, and Δ_{O}_{ᵢ} is the differential term of the node Oᵢ of the output layer.

According to the above features, the differential term of the node Hⱼᵢ of the j^{th} hidden layer hidden layer is expressed as:

Δ_{H}_{ⱼᵢ}=(Σᵢ₌₁^{n′}[Δ_{H}_{₍ⱼ₊₁₎ᵢ}wₓᵢ]);

wherein n′ is a number of the all nodes of the j^{th} hidden layer, w_{x′i} is a weighting of a path between the node Hⱼᵢ of the j^{th} hidden layer corresponding to a weighting w_{x′} and the node H₍ⱼ₊₁₎ᵢ of the (j+1)^{th} hidden layer, and Δ_{H}_{₍ⱼ₊₁₎ᵢ} is the differential term of the node H₍ⱼ₊₁₎ᵢ of the (j+1)^{th} hidden layer.

According to the above features, when updating the updating the all weightings of the paths between the j^{th} hidden layer and the (j−1)^{th} hidden layer, an access number of accessing the memory is M_{Lj}=(2N_{H(j+1)}+2)N_{Hj}N_{H(j-1)}, wherein the N_{Hj} is a number of the all nodes of the j^{th} hidden layer, N_{H(j-1)} is a number of the all nodes of the (j−1)^{th} hidden layer, and the N_{H(j+1)} is a number of the all nodes of the (j+1)^{th} hidden layer. Though the present disclosure increase the access number of accessing the memory (the little increment of the access number of accessing the memory is T_{M}=(2N_{c+1}+2)N_{c}n+N_{c}) when calculating the differential terms of the hidden layers compared to the total access number of accessing the memory the related art, the total access number of accessing the memory by using the above memory access method is greatly reduced, wherein N_{c} and N_{c+1} are respectively the numbers of the nodes of the c^{th} hidden layer and the (c+1)^{th} hidden layer, and n is the number of the weightings of the single one node connected to the arbitrary one hidden layer.

According to one objective of the present disclosure, a deep learning network device is provided. The deep learning network device is implemented by a computer device with a software, or implemented by a hardware circuit, which is characterized by being configured to execute the above memory access method when training the deep learning network.

According to the above features, deep learning network device further comprises: a communication unit, used to communicate with an external electronic device; wherein only when the communication unit is unable to communicate with the external electronic device, the memory access method is executed when training the deep learning network.

According to the above features, the deep learning network device is an edge computing device, an IoT sensor or a sensor for monitoring.

According to one objective of the present disclosure, a non-volatile storage medium, for storing program codes of the above memory access method is provided.

In summary, compared with the related art, the memory access method used for training the deep learning network and the deep learning network device using the memory access method for training provided by the embodiment of the present disclosure can significantly reduce the access number of accessing the memory. Therefore, the present disclosure can effectively reduce training time and memory power consumption.

### BRIEF DESCRIPTIONS OF DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 is a schematic diagram showing a neural network or a full connection layer, which comprises two hidden layers.

FIG. 2 is a schematic diagram showing relation of nodes of the output layer and the nodes of the last hidden layer in the neural network or the full connection layer.

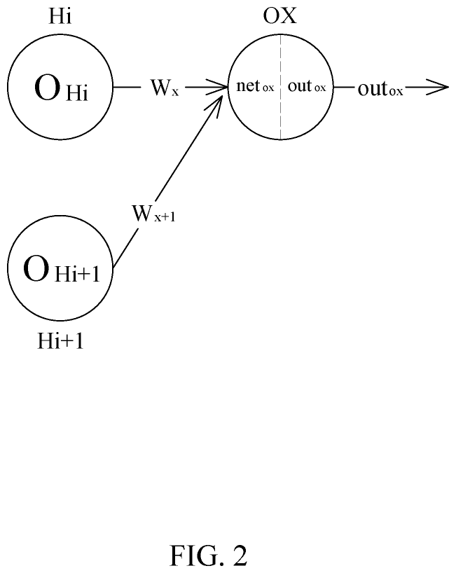

FIG. 3 is a block diagram of a deep learning network device according to a first embodiment of the present disclosure.

FIG. 4 is a block diagram of a deep learning network device according to a second embodiment of the present disclosure.

FIG. 5 is flow chart of a memory access method used in a deep learning network device during training according to an embodiment of the present disclosure.

### DETAILS OF EMBODIMENTS

Reference will now be made in detail to the exemplary embodiments of the present disclosure, examples of which are illustrated in the accompanying drawings. Wherever possible, the same reference numbers are used in the drawings and the description to refer to the same or like parts.

In order to reduce the access number of accessing the memory required to train the full connection layer of the convolution neural network or neural network, the embodiment of the present disclosure provides a memory access method used when training a deep learning network and a deep learning network device using the memory access method during training. Since the access number of accessing the memory is greatly reduced, training time and power consumption can be reduced, and the life time of the battery and memory of the deep learning network device can be prolonged.

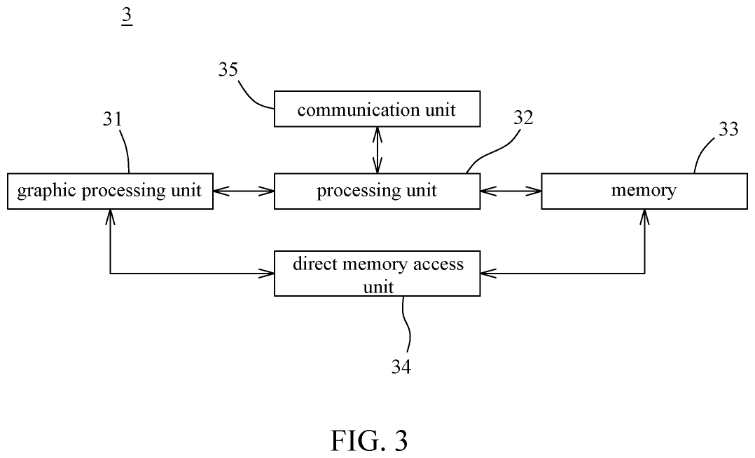

Firstly, refer to FIG. 3, and FIG. 3 is a block diagram of a deep learning network device according to a first embodiment of the present disclosure. The deep learning network device 3 is mainly realized through computer device and software. The deep learning network device 3 comprises a graphic processing unit 31, a processing unit 32, a memory 33, a direct memory access unit 34 and a communication unit 35. The processing unit 32 is electrically connected to the graphic processing unit 31, the memory 33, and communication unit 35, and the direct memory access unit 34 is electrically connected to the graphic processing unit 31 and the memory 33.

In one of the implementations, the graphic processing unit 31 is used to perform the calculation of determination and training of the deep learning network under the control of the processing unit 32, and can directly access the memory 33 through the direct memory access unit 34. In another implementation, the direct memory access unit 34 can be removed, and the graphic processing unit 31 is used to the calculation of determination and training of the deep learning network under the control of the processing unit 32, but the memory 33 must be accessed through the processing unit 32. In yet another implementation, the processing unit 32 performs the calculation of determination and training of the deep learning network, and in this implementation, the direct memory access unit 34 and the graphic processing unit 31 can be removed.

The communication unit 35 is used to communicate with an external electronic device, such as a cloud computing device. When the communication unit 35 can communicate with an external electronic device, the training of the deep learning network can be performed by the external electronic device communication; when the communication unit 35 cannot communicate with the external electronic device (for example, a natural disaster occurs and the network is disconnected, and the deep learning network device 3 is a rescue aerial camera with the limited battery capacity, which should be trained regularly or irregularly to accurately interpret the rescue images), and the training of the deep learning network is carried out by the deep learning network device 3. In the embodiment of the present disclosure, the training of the deep learning network can only train the neural network or the full connection layer. For example, in the case of transfer learning, only the full connection layer is trained, or in another case, the entire convolution neural network may be trained (including training of feature filter matrices, etc.), and the present disclosure is not limited thereto.

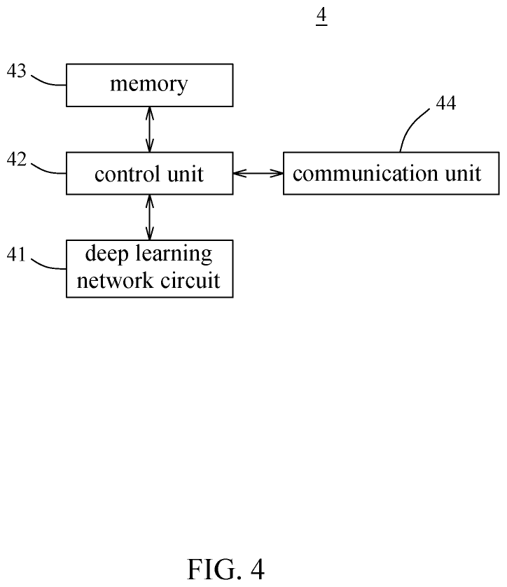

Further, refer to FIG. 4, and FIG. 4 is a block diagram of a deep learning network device according to a second embodiment of the present disclosure. Being different from the first embodiment, the deep learning network device 4 is mainly implemented by pure hardware circuits (for example, but not limited to a field programmable gate array (FPGA) or a specific application integrated chip (ASIC)). The deep learning network device 4 comprises a deep learning network circuit 41, a control unit 42, a memory 43 and a communication unit 44, wherein the control unit 42 is electrically connected to the deep learning network circuit 41, the memory 43 and the communication unit 44. The deep learning network circuit 41 is used to perform the calculations of the determination and training of the deep learning network, and access the memory 43 through the control unit 42.

The communication unit 44 is used to communicate with an external electronic device, such as a cloud computing device. When the communication unit 44 can communicate with the external electronic device, the training of the deep learning network can be performed by the external electronic device communication; when the communication unit 44 cannot communicate with the external electronic device, the training of the deep learning network is performed by the deep learning network device 4. In the embodiment of the present disclosure, the training of the deep learning network may only refer to the training of the neural network or the full connection layer (in the case of transfer learning), or it may also include the training of the entire convolution neural network (including the training of the feature filter matrices, etc.), and the present disclosure is not limited thereto. By the way, the deep learning network device 3 or 4 can be an edge computing device, an IoT sensor or a sensor for monitoring, and the present disclosure is not limited thereto.

The deep learning network device 3 or 4 will train the neural network or the full connection layer, starting from the output layer to the previous layer, and gradually updating the weightings layer by layer (that is, using the back propagation method). In order to reduce the access number of accessing the memory 33 or 43, when deep learning network device 3 or 4 updates the weightings of paths between the current layer and the previous layer, the differential term of each node of the current layer is stored in the memory 33 or 43. For example, when updating the weightings of the paths between the output layer and the last hidden layer, the differential term of each node of the output layer will be stored in the memory 33 or 43, and when updating the weightings of the paths between the third and second hidden layers, the differential term of each node of the third hidden layer is stored in the memory 33 or 43. In this way, when updating the weightings of the paths between the current layer and the previous layer, the differential terms of the next layer of the current layer can be repeatedly used to reduce the access number of accessing the memory 33 or 43. For example, when updating the weights of the paths between the second hidden layer and the first hidden layer, the differential terms of the nodes of the third hidden layer (or the nodes of the output layer, if there are only two hidden layers) can be used.

The differential term of the node Oₓ of the output layer can be defined as:

Δ_{O}_{ₓ}=(out_{O}_{ₓ}−Y_{O}_{ₓ})D(Act_fn)_{O}_{ₓ}, EQUATION(7).

By using EQUATION (7), the EQUATION (6) can be written as:

$$\frac{\partial L}{\partial {w}_{x}} = {\sum }_{i = 1}^{n} [ {Δ}_{{O}_{i}} {w}_{xi} ] {D ( Act\_fn )}_{{H}_{p}} {O}_{{H}_{q}} , \qquad EQUATION ( 8 )$$

wherein wₓᵢ is a weighting of a path between the node Hₚ of the last hidden layer corresponding to the weighting wₓ and the node Oᵢ of the output layer. By using the differential term of the node Oᵢ of the output layer, when updating the weightings of the paths between the last hidden layer and the previous layer (the second last hidden layer or input layer if there is merely one hidden layer) and calculating the derivative function

$$( \frac{\partial L}{\partial {w}_{x}} )$$

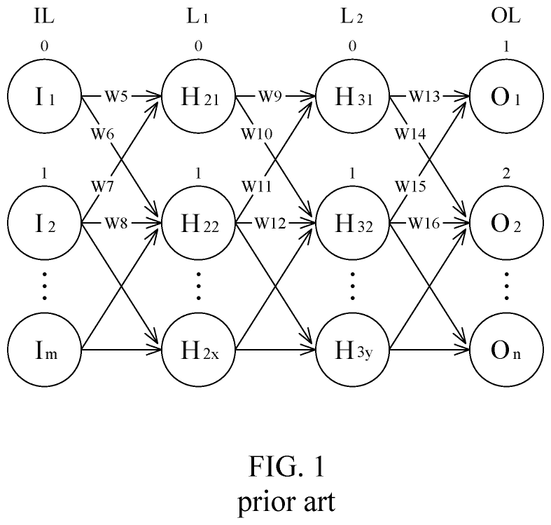

of the loss function L over wₓ, to obtain the required values for calculating, the required access number of accessing the memory is (N_{OL}+2). Take FIG. 1 as example, when updating the weightings of the paths between the 2^{nd} hidden layer and the 1^{st} hidden layer, the required access number of accessing the memory is totally M_{LL}=(2N_{OL}+2)N_{L1}N_{L2}. Simply, compared to the related art, totally N_{OL}N_{L1}N_{L2} times of accessing the memory can be reduced.

If there are L hidden layers, when updating the weightings of the paths between the L^{th} hidden layer and the (L−1)^{th} hidden layer, the differential terms of all the nodes of the L^{th} hidden layer are stored in the memory. Each of the differential terms of all the nodes of the L^{th} hidden layer can be expressed as:

Δ_{H}_{_{Li}}=(Σᵢ₌₁ⁿ[Δ_{O}_{ᵢ}wₓᵢ]), EQUATION(9);

wherein wₓᵢ is a weighting of a path between the node H_{Li} of the L^{th} hidden layer corresponding to a weighting wₓ and the node Oᵢ of the output layer. Therefore, when updating the weighting wₓ of the path between the (L−1)^{th} hidden layer and the (L−2)^{th} hidden layer, the derivative function

$$( \frac{\partial L}{\partial {w}_{x}} )$$

of the loss function L over wₓ can be expressed as:

$$\frac{\partial L}{\partial {w}_{x}} = {\sum }_{i = 1}^{k} [ {Δ}_{{H}_{Li}} {w}_{xi} ] {D ( Act\_fn )}_{{H}_{( L - 1 ) p}} {O}_{{H}_{( L - 2 ) q}} , \qquad EQUATION ( 10 )$$

wherein D(Act_fn)_{H}_{_{(L−1)p}} is the derivative function of the activation function of the node H_{(L-1)p} of the (L−1)^{th} hidden layer, k is the number of the node of the L^{th} hidden layer, and O_{H}_{_{(L−2)q}} is the output value of the node H_{H(L-2)q} corresponding to the weighting wₓ (i.e. the node H_{H(L-2)q} of the (L−2)^{th} hidden layer connected to the node H_{H(L-1)p} of the (L−1)^{th} hidden layer). By using the differential terms of all the nodes of the L^{th} hidden layer, when updating the weighting wₓ of the path between the (L−1)^{th} hidden layer and the (L−2)^{th} hidden layer and calculating the derivative function

$$( \frac{\partial L}{\partial {w}_{x}} )$$

or me loss function L over wₓ, to obtain the required values for calculating, the memory needs to be accessed (N_{HL}+2) times, wherein N_{HL} is the number of the node of the L^{th} hidden layer. When updating the all weightings of the path between the (L−1)^{th} hidden layer and the (L−2)^{th} hidden layer, the memory needs to be accessed M_{OL}=(N_{HL}+2)N_{H(L-1)}N_{H(L-2)} times, wherein N_{H(L-1)} is the number of the node of the (L−1)^{th} hidden layer, and N_{H(L-2)} is the number of the node of the (L−2)^{th} hidden layer. Simply, compared to the related art, totally 3N_{OL}N_{HL}N_{H(L-1)}N_{H(L-2)} times for accessing the memory can be reduced during this updating.

According to the above descriptions, when updating the weightings of the paths between the j^{th} hidden layer and the (j−1)^{th} hidden layer, the differential terms of all the nodes of the j^{th} hidden layer are stored in the memory. Each of the differential terms of all the nodes of the j^{th} hidden layer can be expressed as:

Δ_{H}_{ⱼᵢ}=(Σᵢ₌₁^{n′}[Δ_{H}_{₍ⱼ₊₁₎ᵢ}wₓᵢ] EQUATION(11);

wherein n′ is the number of the node of the j^{th} hidden layer, and wₓᵢ is a weighting of a path between the node Hⱼᵢ of the j^{th} hidden layer hidden layer corresponding to a weighting wₓ and the node H₍ⱼ₊ᵢ₎ᵢ of the (j+1)^{th} hidden layer. Therefore, when updating the weighting wₓ of the path between the (j−1)^{th} hidden layer and the (j−2)^{th} hidden layer, the derivative function

$$( \frac{\partial L}{\partial {w}_{x}} )$$

of the loss function L over wₓ can be expressed as:

$$\frac{\partial L}{\partial {w}_{x}} = {\sum }_{i = 1}^{{k}^{′}} [ {Δ}_{{H}_{ji}} {w}_{xi} ] {D ( Act\_fn )}_{{H}_{( j - 1 ) p}} {O}_{{H}_{( j - 2 ) q}} , \qquad EQUATION ( 12 )$$

wherein D(Act_fn)_{H}_{_{(j−1)p}} is the derivative function of the activation function of the node H₍ⱼ₋₁₎ₚ of the (j−1)^{th} hidden layer, k′ is the number of the node of the j^{th} hidden layer, and O_{H}_{_{(j−2)q}} is the output value of the node H_{(j-2)q} corresponding to the weighting wₓ (i.e. the node H_{(j-2)q} of the (j−2)^{th} hidden layer connected to the node H₍ⱼ₋₁₎ₚ of the (j−1)^{th} hidden layer). By using the differential terms of all the nodes of the j^{th} hidden layer, when updating the weighting wₓ of the path between the (j−1)^{th} hidden layer and the (j−2)^{th} hidden layer and calculating the derivative function

$$( \frac{\partial L}{\partial {w}_{x}} )$$

or me loss function L over wₓ, to obtain the required values for calculating, the memory needs to be accessed (N_{Hj}, +2) times, wherein N_{Hj} is the number of the node of the j^{th} hidden layer. When updating the all weightings of the path between the (j−1)^{th} hidden layer and the (j−2)^{th} hidden layer, the memory needs to be accessed M_{L(j-1)}=(2N_{Hj}+2)N_{H(j-1)}N_{H(j-2)} times, wherein N_{H(j-1)} is the number of the node of the (j−1)^{th} hidden layer, and N_{H(j-2)} is the number of the node of the (j−2)^{th} hidden layer.

When updating the weighting wₓ of the path between the 1^{st} hidden layer and the input hidden layer, the derivative function

$$( \frac{\partial L}{\partial {w}_{x}} )$$

of the loss function L over wₓ can be expressed as:

$$\frac{\partial L}{\partial {w}_{x}} = {\sum }_{i = 1}^{{k}^{″}} [ {Δ}_{{H}_{2 i}} {w}_{xi} ] {D ( Act\_fn )}_{{H}_{1 p}} {O}_{{I}_{q}} , \qquad EQUATION ( 13 )$$

wherein D(Act_fn)H₁ₚ is the derivative function of the activation function of the node H₁ₚ of the 1^{st} hidden layer, k″ is the number of the node of the 2^{nd} hidden layer, and O_{I}_{_{q}} is the output value of the node I_{q} corresponding to the weighting wₓ (i.e. the node I_{q} of the input layer connected to the node H₁ₚ of the 1^{st} hidden layer). By using the differential terms of all the nodes of the 2^{nd} hidden layer, when updating the weighting wₓ of the path between the 1^{st} hidden layer and the input layer and calculating the derivative function

$$( \frac{\partial L}{\partial {w}_{x}} )$$

of the loss function L over wₓ, to obtain the required values for calculating, the memory needs to be accessed (N_{H2}+2) times, wherein N_{H2} is the number of the node of the 2^{nd} hidden layer. When updating the all weightings of the path between the 1^{st} hidden layer and the input layer, the memory needs to be accessed M_{L1}=(2N_{H2}+2)N_{H1}N_{IL} times, wherein N_{H1} is the number of the node of the 1^{st} hidden layer, and N_{IL} is the number of the node of the input layer.

Please note here that when updating the weightings of the paths between the first hidden layer and the input layer, because all the differential terms of the first hidden layer will not be used later, there is no need to access the memory to store these differential terms of the first hidden layer. In addition, through the above-mentioned memory access method, memory requires additional memory space to record the differential terms Δ_{O}_{ᵢ} and Δ_{H}_{ⱼᵢ}, but the increased memory space is not large, only additional storage space for storing (N_{OL}+N_{HL} N_{H2}) difference terms is added.

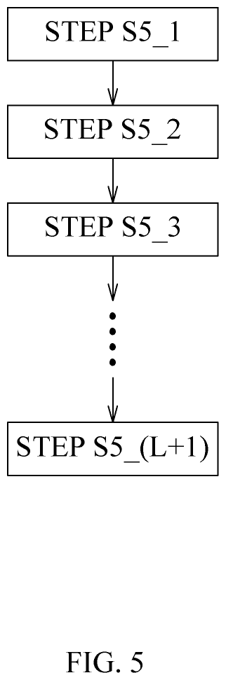

Further, please refer to FIG. 5. The neural network or the full connection layer is composed of an input layer, L hidden layers and an output layer, and therefore, there are steps S5_1 to S5_(L+1) to be executed. At step S5_1, weightings of paths between the output layer and a L^{th} hidden layer of the L hidden layers are updated, and differential terms of all nodes of the output layer are stored in a memory. Then, at step S5_2, weightings of paths between the L^{th} hidden layer and a (L−1)^{th} hidden layer of the L hidden layers are updated, and differential terms of all nodes of the L^{th} hidden layer are stored in a memory, wherein when updating the weightings of the paths between the L^{th} hidden layer and the (L−1)^{th} hidden layer, the memory is accessed, and the differential terms of the all nodes of the output layer are used for updating. Next, at step S5_3, weightings of paths between the (L−1)^{th} hidden layer and a (L−2)^{th} hidden layer of the L hidden layers are updated, and differential terms of all nodes of the (L−1)^{th} hidden layer are stored in a memory, wherein when updating the weightings of the paths between the (L−2)^{th} hidden layer and the (L−2)^{th} hidden layer, the memory is accessed, and the differential terms of the all nodes of the L^{th} hidden layer are used for updating. Step S5_4 to step S5_L can be known in the similar manner. Last, at step S5_(L+1), weightings of paths between the input layer and a 1^{st} hidden layer of the L hidden layers are updated, wherein when updating the weightings of the paths between the input layer and the 1^{st} hidden layer, the memory is accessed, and the differential terms of the all nodes of the 2^{nd} hidden layer are used for updating. In addition, an embodiment of the present disclosure also provides a non-volatile storage medium for storing multiple program codes of the above-mentioned memory access method.

Specifically, the embodiment of the present disclosure provides a memory access method used when training a deep learning network and a training deep learning network device using the memory access method. Since the memory access method greatly reduces the access number of accessing the memory, training time and power consumption can be reduced, and the battery and memory life time of the deep learning network device can be prolonged. Especially in the case of limited battery power, the deep learning network device can run longer.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A memory access method, which is used when training a deep learning network, wherein the deep learning network is a neural network or a convolution neural network, the neural network or a full connection layer of the convolution neural network comprises an input layer, L hidden layers and an output layer, and the memory access method comprises:
updating weightings of paths between the output layer and a L^{th} hidden layer of the L hidden layers, and storing differential terms of all nodes of the output layer in a memory;
updating weightings of paths between the L^{th} hidden layer and a (L−1)^{th} hidden layer of the L hidden layers based on the differential terms of the all nodes of the output layer stored in the memory, and storing differential terms of all nodes of the L^{th} hidden layer in the memory;
updating weightings of paths between j^{th} hidden layer of the L hidden layers and a (j−1)^{th} hidden layer of the L hidden layers based on differential terms of all nodes of a (j+1)^{th} hidden layer of the L hidden layers stored in the memory, and storing differential terms of all nodes of the j^{th} hidden layer in the memory, wherein j is an integer from 2 to (L−1); and
updating weightings of paths between the input layer and a 1^{st} hidden layer of the L hidden layers based on differential terms of all nodes of a 2^{nd} hidden layer of the L hidden layers stored in the memory.

2. The memory access method of claim 1, wherein the deep learning network is a convolution neural network, and a transfer learning is used to only train the full connection layer of the convolution neural network.

3. The memory access method of claim 1, wherein the differential term of the node Oₓ of the output layer is expressed as:
Δ_{O}_{ₓ}=(out_{O}_{ₓ}−Y_{O}_{ₓ})D(Act_fn)_{O}_{ₓ};
wherein Y_{O}_{ₓ} is a target value of the node Oₓ of the output layer, D(Act_fn)_{O}_{ₓ} is a derivative function of an activation function of the node Oₓ of the output layer.

4. The memory access method of claim 3, wherein the differential term of the node H_{Li} of the L^{th} hidden layer is expressed as:
Δ_{H}_{_{Li}}=(Σᵢ₌₁ⁿ[Δ_{O}_{ᵢ}wₓᵢ]);
wherein n is a number of the all nodes of the output layer, wₓᵢ is a weighting of a path between the node H_{Li} of the L^{th} hidden layer corresponding to a weighting wₓ and the node Oᵢ of the output layer, and Δ_{O}_{ᵢ} is the differential term of the node Oᵢ of the output layer.

5. The memory access method of claim 4, wherein the differential term of the node Hⱼᵢ of the j^{th} hidden layer hidden layer is expressed as:
Δ_{H}_{ⱼᵢ}=(Σᵢ₌₁^{n′}[Δ_{H}_{₍ⱼ₊₁₎ᵢ}w_{x′i}]);
wherein n′ is a number of the all nodes of the j^{th} hidden layer, w_{x′i} is a weighting of a path between the node Hⱼᵢ of the j^{th} hidden layer corresponding to a weighting wₓ, and the node H₍ⱼ₊₁₎ᵢ of the (j+1)^{th} hidden layer, and Δ_{H}_{₍ⱼ₊₁₎ᵢ} is the differential term of the node H₍ⱼ₊₁₎ᵢ of the (j+1)^{th} hidden layer.

6. The memory access method of claim 5, wherein when updating the updating the all weightings of the paths between the j^{th} hidden layer and the (j−1)^{th} hidden layer, an access number of accessing the memory is M_{Lj}=(2N_{H(j+1)}+2)N_{Hj}N_{H(j-1)}, wherein the N_{Hj} is a number of the all nodes of the j^{th} hidden layer, N_{H(j-1)} is a number of the all nodes of the (j−1)^{th} hidden layer, and the N_{H(j+1)} is a number of the all nodes of the (j+1)^{th} hidden layer.

7. A deep learning network device, implemented by a computer device with a software, or implemented by a hardware circuit, which is characterized by being configured to execute the memory access method of claim 1 when training the deep learning network.

8. The deep learning network device of claim 7, further comprising:
a communication unit, used to communicate with an external electronic device;
wherein only when the communication unit is unable to communicate with the external electronic device, the memory access method is executed when training the deep learning network.

9. The deep learning network device of claim 7, wherein the deep learning network device is an edge computing device, an IoT sensor or a sensor for monitoring.

10. The deep learning network device of claim 7, wherein the deep learning network is a convolution neural network, and a transfer learning is used to only train the full connection layer of the convolution neural network.

11. The deep learning network device of claim 7, wherein the differential term of the node Oₓ of the output layer is expressed as:
Δ_{O}_{ₓ}=(out_{O}_{ₓ}−Y_{O}_{ₓ})D(Act_fn)_{O}_{ₓ};
wherein Y_{O}_{ₓ} is a target value of the node Oₓ of the output layer, D(Act_fn)_{O}_{ₓ} is a derivative function of an activation function of the node Oₓ of the output layer.

12. The deep learning network device of claim 11, wherein the differential term of the node H_{Li} of the L^{th} hidden layer is expressed as:
Δ_{H}_{_{Li}}=(Σᵢ₌₁ⁿ[Δ_{O}_{ᵢ}wₓᵢ]);
wherein n is a number of the all nodes of the output layer, wₓᵢ is a weighting of a path between the node H_{Li} of the L^{th} hidden layer corresponding to a weighting wₓ and the node Oᵢ of the output layer, and Δ_{O}_{ᵢ} is the differential term of the node Oᵢ of the output layer.

13. The deep learning network device of claim 12, wherein the differential term of the node Hⱼᵢ of the j^{th} hidden layer hidden layer is expressed as:
Δ_{H}_{ⱼᵢ}=(Σᵢ₌₁^{n′}[Δ_{H}_{₍ⱼ₊₁₎ᵢ}w_{x′i}]);
wherein n′ is a number of the all nodes of the j^{th} hidden layer, w_{x′i} is a weighting of a path between the node Hⱼᵢ of the j^{th} hidden layer corresponding to a weighting wₓ, and the node H₍ⱼ₊₁₎ᵢ of the (j+1)^{th} hidden layer, and Δ_{H}_{₍ⱼ₊₁₎ᵢ} is the differential term of the node H₍ⱼ₊₁₎ᵢ of the (j+1)^{th} hidden layer.

14. The deep learning network device of claim 13, wherein when updating the updating the all weightings of the paths between the j^{th} hidden layer and the (j−1)^{th} hidden layer, an access number of accessing the memory is M_{Lj}=(2N_{H(j+1)}+2)N_{Hj}N_{H(j-1)}, wherein the N_{Hj} is a number of the all nodes of the j^{th} hidden layer, N_{H(j-1)} is a number of the all nodes of the (j−1)^{th} hidden layer, and the N_{H(j+1)} is a number of the all nodes of the (j+1)^{th} hidden layer.

15. A non-volatile storage medium, for storing program codes of the memory access method of claim 1.

16. The non-volatile storage medium of claim 15, wherein the deep learning network is a convolution neural network, and a transfer learning is used to only train the full connection layer of the convolution neural network.

17. The non-volatile storage medium of claim 15, wherein the differential term of the node Oₓ of the output layer is expressed as:
Δ_{O}_{ₓ}=(out_{O}_{ₓ}−Y_{O}_{ₓ})D(Act_fn)_{O}_{ₓ};
wherein Y_{O}_{ₓ} is a target value of the node Oₓ of the output layer, D(Act_fn)_{O}_{ₓ} is a derivative function of an activation function of the node Oₓ of the output layer.

18. The non-volatile storage medium of claim 17, wherein the differential term of the node H_{Li} of the L^{th} hidden layer is expressed as:
Δ_{H}_{_{Li}}=(Σᵢ₌₁ⁿ[Δ_{O}_{ᵢ}wₓᵢ]);
wherein n is a number of the all nodes of the output layer, wₓᵢ is a weighting of a path between the node H_{Li} of the L^{th} hidden layer corresponding to a weighting wₓ and the node Oᵢ of the output layer, and Δ_{O}_{ᵢ} is the differential term of the node Oᵢ of the output layer.

19. The non-volatile storage medium of claim 18, wherein the differential term of the node Hⱼᵢ of the j^{th} hidden layer hidden layer is expressed as:
Δ_{H}_{ⱼᵢ}=(Σᵢ₌₁^{n′}[Δ_{H}_{₍ⱼ₊₁₎ᵢ}w_{x′i}]);
wherein n′ is a number of the all nodes of the j^{th} hidden layer, w_{x′i} is a weighting of a path between the node Hⱼᵢ of the j^{th} hidden layer corresponding to a weighting wₓ, and the node H₍ⱼ₊₁₎ᵢ of the (j+1)^{th} hidden layer, and Δ_{H}_{₍ⱼ₊₁₎ᵢ} is the differential term of the node H₍ⱼ₊₁₎ᵢ of the (j+1)^{th} hidden layer.

20. The non-volatile storage medium of claim 19, wherein when updating the updating the all weightings of the paths between the j^{th} hidden layer and the (j−1)^{th} hidden layer, an access number of accessing the memory is M_{Lj}=(2N_{H(j+1)}+2)N_{Hj}N_{H(j-1)}, wherein the N_{Hj} is a number of the all nodes of the j^{th} hidden layer, N_{H(j-1)} is a number of the all nodes of the (j−1)^{th} hidden layer, and the N_{H(j+1)} is a number of the all nodes of the (j+1)^{th} hidden layer.
